(19) United States
(12) Patent Application Publication
(10) Pub. No.: US 2008/0098655 A1
(43) Pub. Date: May 1, 2008

(54) Integrated bracket for mounting pulley

(76) Inventor: Jeffrey Valentage, Royal Oak, MI (US)

Correspondence Address: ExxonMobil Chemical Company;Law Technology, P.O. Box 2149, Baytown, TX, 77522-2149, US

(21) Appl. No.: 11/590,307

(22) Filed: Oct. 31, 2006

(51) Int. Cl. E05F 11/48

(52) U.S. Cl. 49/352

(57) ABSTRACT

A door window system is provided. In at least one embodiment, the door window system includes a core module, window track, a window track glass guide operatively engaged with the window track to be guided along the profile of the window track, a bracket integrally formed on the core module, and a pulley attached to the bracket wherein the pulley is in communication with a cable that is attached to the window track glass guide.

### BACKGROUND OF THE INVENTION

1. Field of the Invention

This invention relates to door window systems. More particularly, embodiments of the present invention relate to door window systems for vehicles, such as automobiles, specifically cars and trucks.

2. Description of the Related Art

Conventional doors for automobiles contain many individual pieces that are assembled to a frame or shell on an assembly line. Automotive doors can have more than fifty to greater than one hundred individual components or parts depending on the vehicle and option package. Components are typically supplied by a different vendor or supplier, some of which are known in the industry as Tier 1, Tier 2, and Tier 3 suppliers. The numerous individual components from the Tier 1, 2, and 3 suppliers are then assembled onto the original equipment manufacturer's (OEM's) door shell, typically at the OEM's assembly line.

The process of affixing the components to the door shell is intensive and requires costly logistical considerations and/or systems to assure the right parts are at the right place at the right time. The assembly process can also demand a large amount of costly floor space. Each component is attached to the door shell using at least one of many different means including clips, screws, fittings, adhesives, just to name a few. In most cases, twenty to forty five different assembly steps are needed to complete the entire assembly process of the door.

The assembly process also requires a high degree of logistical planning to ensure all the parts are available and assembled in the correct manner and order. Other incidental and related costs include ordering, storage, management, transportation, functionality testing, quality control, in addition to the floor space to assemble the various components. All those factors add up to a time consuming and costly end product.

Specifically, the assembly process for a window requires multiple assembly steps involving spaces, rivets, stamped brackets, along with many other additional components. All of these components must be individually attached on the assembly line.

There is a need, therefore, for a door window assembly having fewer individual components. There is also a need for a door window assembly that minimizes the number of individual components requiring assembly. There is a further need for a door window design that simplifies the assembly process.

### SUMMARY OF THE INVENTION

A door window system is provided. In at least one embodiment, the door window system includes a core module, a window track, a window track glass guide operatively engaged with the window track to be guided along the profile of the window track, a bracket integrally formed on the core module, and a pulley attached to the bracket wherein the pulley is in communication with a cable that is attached to the window track glass guide.

### BRIEF DESCRIPTION OF THE DRAWINGS

FIG. 1 is a schematic illustration of a conventional door window as used in the prior art.

FIG. 2 is a schematic illustration of a conventional door window as used in the prior art.

FIG. 3 is a schematic view of one illustrative embodiment of an inventive door window system.

FIG. 4 is a schematic view of one illustrative embodiment of an inventive door window system.

FIG. 5 is a schematic view of one illustrative embodiment of a window lift system.

FIG. 6 is a schematic view of one illustrative embodiment of a window track glass guide.

FIG. 7 is a schematic view of one illustrative embodiment of a trim panel.

### DETAILED DESCRIPTION OF THE INVENTION

A detailed description will now be provided. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

A door window system is provided. In at least one embodiment, the door window system includes core module, a window track, a window track glass guide operatively engaged with the window track to be guided along the profile of the window track, a bracket integrally formed on the core module, and a pulley attached to the bracket wherein the pulley is in communication with a cable that is attached to the window track glass guide.

As used herein the term “door” is intended to include any door. For example, the term “door” can refer to one or more passenger doors, whether hinged, sliding, lifting or with any other alternative opening/closing movement, lift gates, tail gates, and hatchbacks for any vehicle including cars, trucks, sport utility vehicles (SUVs), trains, boats, airplanes, etc., whether for personal, recreational or commercial use.

As used herein the term “window” is intended to include any window. For example, the term “window” can refer to any one of the windows for any vehicle including cars, trucks, SUV's, trains, boats, airplanes, etc., whether for personal, recreational or commercial use.

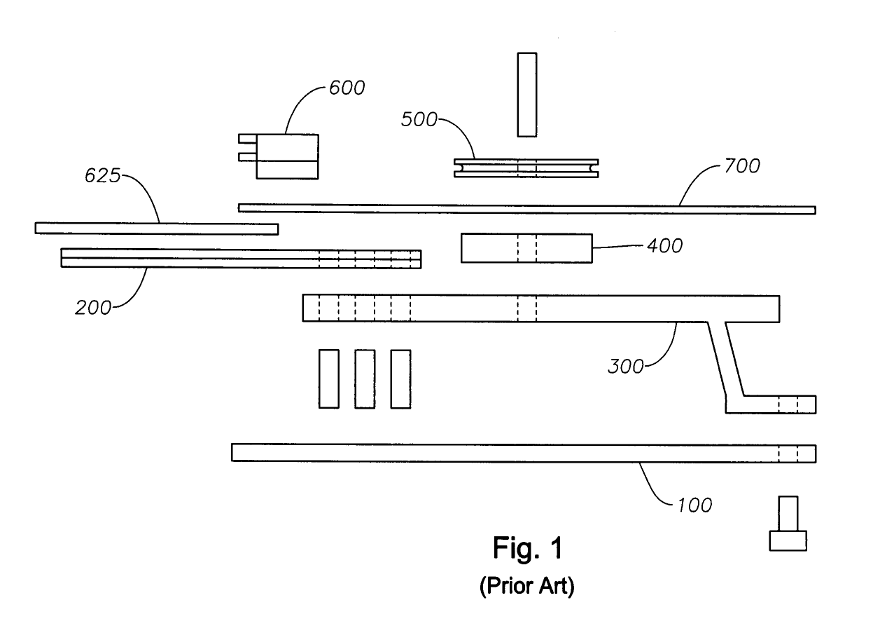

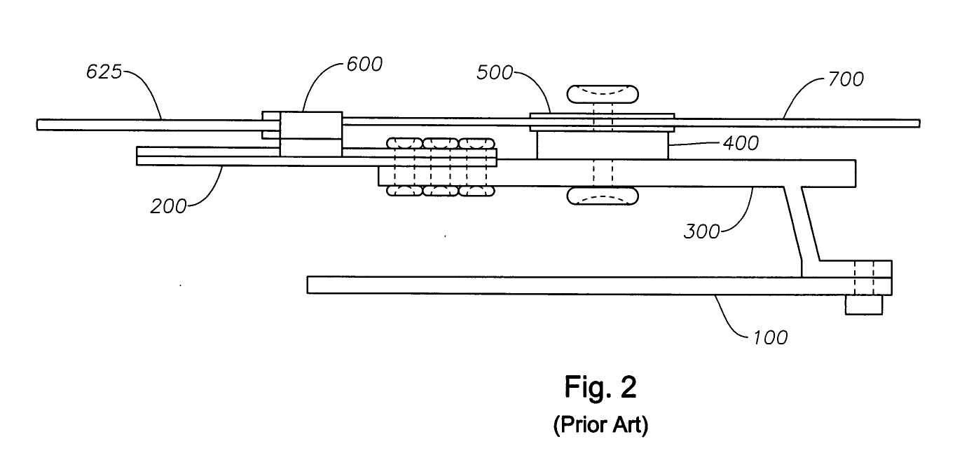

FIGS. 1 and 2 show a schematic illustration of a conventional door window system. In this embodiment, bracket 300 is riveted to the core module 100, pulley 500 is riveted to bracket 300, and window track 200 is also riveted to bracket 300.

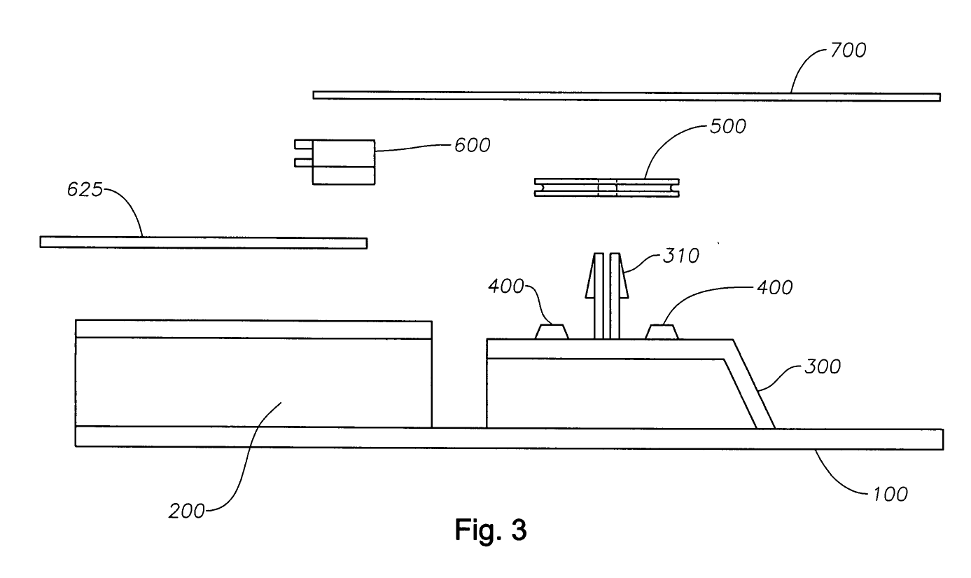

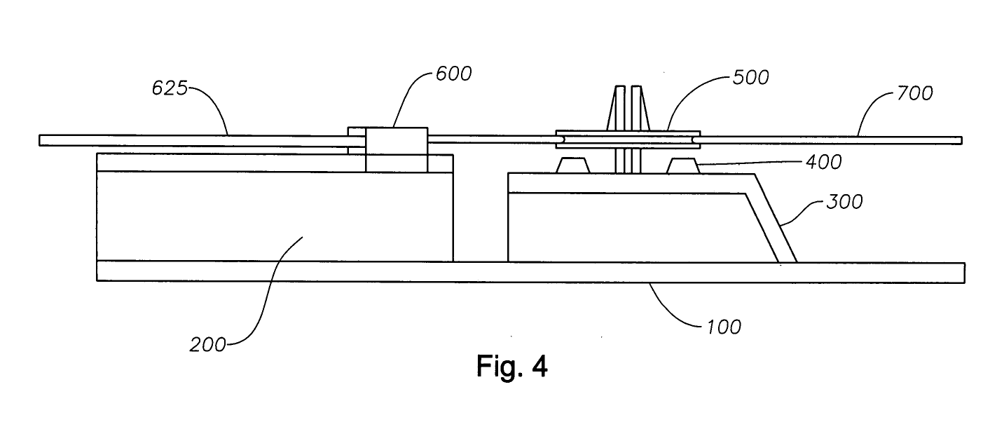

FIGS. 3 and 4 show a schematic view of an illustrative door window system according to one or more embodiments of the present invention. In at least one specific embodiment, the door window system includes a core module 100, window track 200, bracket 300, spacer 400, pulley 500, window glass track guide 600, and cable 700.

The core module 100 provides a body or substrate for one or more hardware components, electrical components and sealing components attached to or otherwise assembled thereon. Illustrative components assembled to the core module 100 include, but are not limited to window regulators; motors; tracks; impact bolsters; wire harnesses; speaker boxes or receptacles; speakers; window motors; outside mirror motors; beltline seals; plugs; grommets; and core to frame seals. It is to be understood that the core module 100 can include any other component typical of an automotive door.

Preferably, various components can be integrally formed on the core module 100. For example, any combination of the one or more brackets 300, the one or more spacers 400, and the one or more window tracks 200, can be integrally formed with the core module 100. Examples of ways to integrally form the components to the core module include, but are not limited to, any type of injection molding including any single material, multi-material or multi-shot injection molding techniques. Further, any of the embodiments discussed can include any combination of integrally formed parts, whether or not those parts are specifically discussed in those embodiments. As such, any embodiment that discusses multiple integrally formed parts can exist without every discussed part present.

Multi-material injection molding techniques allow two or more materials to be injection molded into a single or multiple cavity molds. A two component or material process is commonly known as “2K” and a three material process is commonly known as “3K.” Any suitable multi-material injection molding machine can be used, such as an Engel Victory Combi machine available from Engel Corp. Additional in-mold processing techniques can also be used to enhance and/or facilitate the integration. Illustrative in-mold processing techniques include, but are not limited to, multiple cavity tools, insert molding, movable core sections, and gas/water assist. Robotic extrusion can also be used alone or in combination with any of these processing techniques. Robotic extrusion is particularly useful for applying the sealing members into the injection mold.

As shown in FIGS. 3-4, bracket 300 and spacer 400 are integrally formed to the exterior side of the core module 100. As used herein, the term “interior” refers to an orientation or direction facing toward the passenger compartment or inside of the vehicle, and the term “exterior” refers to an orientation or direction facing away from the passenger compartment or inside of the vehicle. In the embodiment shown in FIG. 3, bracket 300 includes a snap fit portion 310 to attach pulley 500 to the core module 100 without the use of any additional fasteners. In addition to the attachment means shown in FIG. 3, the pulley in this embodiment can be attached to the bracket using any means not requiring additional fasteners. Additional means to attach the bracket to the pulley include, but are not limited to, interlocking connectors, screw connectors, bayonet connectors, adhesives, and any combination thereof. In an additional embodiment, the spacer 400 can optionally be integrally formed on or attached to the pulley 500. The window 625 is secured to the window track glass guide 600. The window track glass guide 600 can be operatively engaged to the window track 200 so that it can be guided along the profile of the window track 200. The window lift system includes a cable 700 in communication with pulley 500 that is attached to the window track glass guide 600 to move window 625 up and down. While only one of each of the components of the door window system is shown here in FIGS. 3-4, it is contemplated for all embodiments of the present invention that a door window system could contain more than one of each component for any embodiment of the present invention.

In a separate embodiment, a highly integrated door system has any number or the components described herein integrally formed directly on the interior side of the door shell (not shown). In this embodiment, any combination of the components described above, including the one or more brackets 300, the one or more spacers 400, and the one or more window tracks 200, can be integrally formed on the door shell. In this embodiment, a core module 100 or trim panel 900 would be optional. Bracket 300 includes a snap fit portion 310 to attach pulley 500 to the door shell without the use of any additional fasteners. The window 625 is secured to the window track glass guide 600. The window track glass guide 600 can be operatively engaged to the window track 200 so that it can be guided along the profile of the window track 200. The window lift system includes a cable 700 in communication with pulley 500 that is attached to the window track glass guide 600 to move window 625 up and down.

In a separate embodiment, any of the components described herein can be integrally formed on the exterior side of the trim panel 900 (not shown). In this embodiment, any combination of the components described above, including the one or more brackets 300, the one or more spacers 400, and the one or more window tracks 200, can be integrally formed on the trim panel 900. Bracket 300 includes a snap fit portion 310 to attach pulley 500 to the trim panel 900 without the use of any additional fasteners. The window 625 is secured to the window track glass guide 600. The window track glass guide 600 can be operatively engaged to the window track 200 so that it can be guided along the profile of the window track 200. The window lift system includes a cable 700 in communication with pulley 500 that is attached to the window track glass guide 600 to move window 625 up and down.

For the purposes of this application the term “bracket” will also include any type of fastener that is integrally formed on the core module 100, door shell, or trim panel 900 that holds pulley 500 in place. Preferably, the bracket 300 is either injection molded or insert molded on the core module. The bracket 300 and the core module 100 can be made from the same material or a different combination of materials. Suitable materials for the bracket 300, window track 200, core module 100, trim panel 900, and door shell are discussed in more detail below.

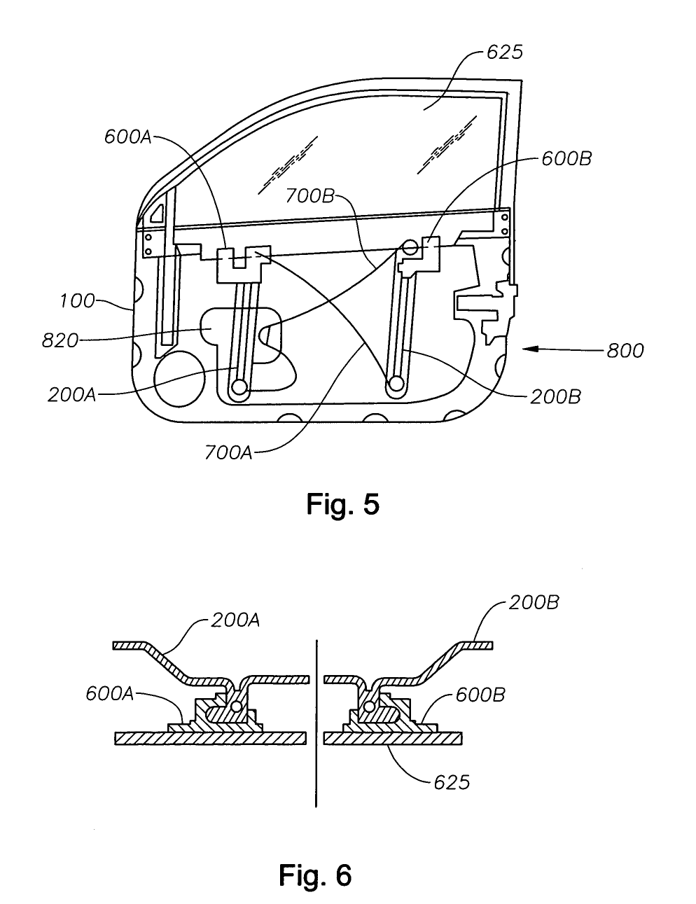

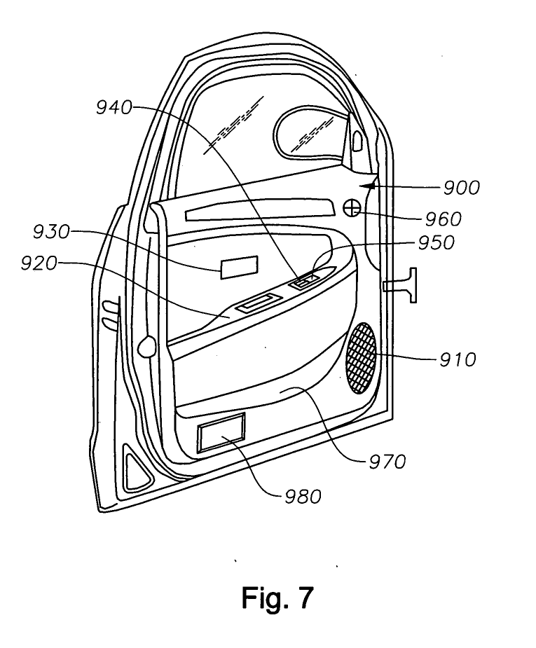

FIGS. 5-6 shows a schematic view of an embodiment of a window lift system 800 of the present invention that can be used with any embodiment described herein. The window lift system 800 includes a motor housing (not shown) and two or more window track glass guides (600A and 600B), each configured on a window track 200A, 200B. A motor 820 is attached to either the motor housing (not shown) or it can be attached directly to the core module 100, door shell (not shown), or trim panel 900 (not shown). The motor housing can be formed on either the interior or exterior side of the core module 100 (not shown), formed on the exterior side of the trim panel (not shown), or formed on the interior of the door shell (not shown). Preferably, the motor housing is injection molded or insert molded on the core module 100. The motor 820 can be easily mounted on or assembled to the integrally formed motor housing using a clip snap connection, rivet, screw, adhesive, or by any other fastener (not shown).

The window 625 is secured to the window track glass guides 600A, 600B by one or more fasteners and/or adhesive type material (not shown). The window track glass guides 600A, 600B and the window tracks 200A, 200B can each be formed to have mating profiles that when engaged the window track glass guides is guided along the profile of its respective track as shown in FIG. 5.

The window lift system 800 further includes one or more Bowden cables (two are shown 700A and 700B in FIG. 5). The cables 700A and 700B are connected to the window track glass guides 600A, 600B. The window track glass guides 600A, 600B move the window 625 up or down when the motor 820 alternately draws the cables 700A and 700B. The window 625 is supported by the window track glass guides 600A, 600B in communication with the tracks 200A and 200B. These tracks can be integrally formed, insert molded, or assembled onto the core module 100, door shell (not shown), or trim panel 900 (not shown).

In a further embodiment, a slip coating (not shown) can be inserted into the mold where the window tracks 200 are formed to reduce friction with the window glass. This can be done using the 2K or multi-material injection techniques or robotic extrusion. Alternatively, the slip coat can be inserted in the tool before the tracks 200 are molded. This can be done, for example, as a coating on a thin polymeric film. Alternatively, a thin polymeric film with a flock coating can be inserted into the tool and overmolded. The slip coating is preferably made of a material that can reduce friction between the window tracks 200 and the window glass 625. The slip coating can be made of polyethylene, polypropylene or other suitable materials, including the materials discussed herein. If the coefficient of friction of the base material from which the seal is made is low enough, it is no longer necessary to add a low friction surface to the seal.

As shown in FIG. 7, the trim panel 900 can further include one or more speaker covers 910, arm rests 920, door handle 930, window switches 940, door lock switches 950, side mirror controls 960, map pockets 970, and interior lights 980. Additionally, the trim panel can include any of the components that are typically integrated or attached to the core module. These include, but are not limited to, one or more brackets, one or more pulleys, and one or more window track glass guides. The trim panel 900 can provide a housing or substrate for other electrical, mechanical and sealing components to be attached or integrally formed thereto. Illustrative components include, but are not limited to, air bags, air vents, switches; door handles; door locks; arm rests; map pockets; speaker covers or grilles; speakers; beltline seals; plugs; grommets; and core to frame seals. Illustrative switches include window glass controls, window locks, outside mirror positioning controls, door locks, seat positioning controls, and stereo controls.

Preferably, the trim panel 900 is injection molded from one or more materials, such as polyethylene, polypropylene and/or one or more other suitable materials described herein. In one or more embodiments, the arm rest 920, speaker cover 910, map pocket 970, bracket 300 (not shown), window tracks 200 (not shown), and any combination thereof are injection molded on the trim panel 900 using multi-material or multi-shot injection molding techniques. Each of the trim panel 900, arm rest 920, speaker cover 910, map pocket 970, bracket 300 (not shown), and window tracks 200 (not shown) can be injection molded from the same or different one or more materials, including polyethylene, polypropylene and/or one or more other suitable materials described herein.

### Assembly Sequence

Referring again to FIGS. 3-4, the door window system can be easily assembled. In general, the one or more components (bracket 300 and/or window tracks 200) are inserted into an injection mold for making the core module 100. The core module 100 and the inserted components are injection molded with a first material. A second material, if needed, such as a thermoplastic vulcanizate (TPV), can be injection molded to create the flexible components (seals, plugs, grommets, or soft touch portions of the skin) on the core module 100. Gas or water assist can also be used to create hollow profiles where needed for additional structure strength. Foaming agents can be used to create foam structures to minimize sink marks or to create a foam structure for increased stiffness. The core module 100 having the integrated components formed thereon is ejected from the tool. Optionally, at this time, the pulley 500 and any other parts of the door that have not yet been integrated to the core module 100 can then assembled to the core module 100. The core module 100 is then ready for delivery to an assembly line.

At the assembly line, any additional parts needed are assembled to the core module 100. The core module 100 is then attached to the door shell, and the trim panel 900 is attached to the door assembly and all connections between the core and the door shell (mechanical, electrical or other). Alternatively, the trim panel 900 can be attached to the core module 100 which is then attached to the door shell. The door assembly is then ready to be assembled to the vehicle. The core module 100 and trip panel can also be assembled prior to delivery to an assembly line

### Materials

The components described, including the door shell, trim panel 900, and core module 100 can be made from any material having the requisite properties, such as stiffness and strength for example. Suitable materials include, but are not limited to, any material used in the current production of automobile doors, propylene homopolymers, propylene copolymers, ethylene homopolymers, ethylene copolymers, and or any one or more of the following polymer resins:

a) polyamide resins such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, nylon 66/PPS copolymer;
b) polyester resins such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer and other aromatic polyesters;
c) polynitrile resins such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS);
d) polymethacrylate resins such as polymethyl methacrylate and polyethylacrylate;
e) cellulose resins such as cellulose acetate and cellulose acetate butyrate;
f) fluorine resins such as polyvinylidene fluoride (PVDF), polyvinyl fluoride (PVF), polychlorofluoroethylene (PCTFE), and tetrafluoroethylene/ethylene copolymer (ETFE);
g) polyimide resins such as aromatic polyimides;
h) polysulfones;
i) polyacetals;
j) polyactones;
k) polyphenylene oxides and polyphenylene sulfides;
l) styrene-maleic anhydrides;
m) aromatic polyketones,
n) polycarbonates (PC);
o) elastomers such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like); and
p) mixtures of any and all of a) through o) inclusive.

In one or more embodiments above or elsewhere herein, the material can include one or more fillers for added strength. Fillers can be present in an amount of from 0.001 wt % to 50 wt % in one embodiment based upon the weight of the composition and from 0.01 wt % to 25 wt % in another embodiment, and from 0.2 wt % to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, sand, glass beads, mineral aggregates, talc, and hydrotalcite compounds of the ions Mg, Ca, or Zn with Al, Cr or Fe and CO₃ and/or HPO₄, hydrated or not; quartz powder, hydrochloric magnesium carbonate, short glass fiber, long glass fiber, glass fibers, polyethylene terephthalate fibers, wollastonite, mica, carbon fiber, nanoclays, nanocomposites, magnesium hydroxide sulfate trihydrate, clays, alumina, and other metal oxides and carbonates, metal hydroxides, chrome, phosphorous and brominated flame retardants, antimony trioxide, silicone, and any combination and blends thereof. Other illustrative fillers can include one or more polypropylene fibers, polyamide fibers, para-aramide fibers (e.g. Kevlar or Twaron), meta-aramide fibers (e.g. Nomex), polyethylene fibers (e.g. Dyneema), and combinations thereof.

The material can also include a nanocomposite, which is a blend of polymer with one or more organo-clays. Illustrative organo-clays can include one or more of ammonium, primary alkylammonium, secondary alkylammonium, tertiary alkylammonium, quaternary alkylammonium, phosphonium derivatives of aliphatic, aromatic or arylaliphatic amines, phosphines or sulfides or sulfonium derivatives of aliphatic, aromatic or arylaliphatic amines, phosphines or sulfides. Further, the organo-clay can be selected from one or more of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite and/or florine mica.

When present, the organo-clay is preferably included in the nanocomposite at from 0.1 to 50 wt %, based on the total weight of the nanocomposite. The stabilization functionality may be selected from one or more of phenols, ketones, hindered amines, substituted phenols, substituted ketones, substituted hindered amines, and combinations thereof. The nanocomposite can further comprise at least one elastomeric ethylene-propylene copolymer, typically present in the nanocomposite at from 1 to 70 wt %, based on the total weight of the nanocomposite.

For areas, sections, or components of the door system 300 that need to provide structure, a reinforced polypropylene (PP) is preferred. Most preferred is a PP reinforced with a PET fiber or any other material that is light weight and provides a good balance of stiffness, impact strength, and has a low coefficient of linear thermal expansion (CLTE).

In one or more embodiments above or elsewhere herein, the polymer can be impact modified to provide improved impact resistance. Impact modifiers include, but are not limited to plastomers, ethylene propylene rubber (EPR), ethylene-propylene diene monomer rubber (EPDM), and may be used in combination with compatibilizers like, but not limited to, maleated polypropylene, maleated polyethylene and other maleated polymers, hydroxilated polypropylene and other hydroxilated polymers, derivatives thereof, and any combination thereof.

In another embodiment, the material can contain a plastomer, preferably a propylene plastomer blend. The term “plastomer” as used herein refers to one or more polyolefin polymers and/or copolymers having a density of from 0.85 g/cm³ to 0.915 g/cm³ according to ASTM D4703 Method B or ASTM D 1505, and a melt index (MI) between 0.10 dg/min and 30 dg/min according to ASTM D 1238 at 190° C., 2.1 kg). Preferred plastomers have a melt index (MI) of between 0.10 dg/min and 20 dg/min in one embodiment, and from 0.2 dg/min to 10 dg/min in another embodiment, and from 0.3 dg/min to 8 dg/min in yet another embodiment as measured by ASTM D 1238 (190° C., 2.1 kg). Preferred plastomers can have an average molecular weight of from 10,000 to 800,000 in one embodiment and from 20,000 to 700,000 in another embodiment. The molecular weight distribution (Mw/Mn) of desirable plastomers ranges from 1.5 to 5 in one embodiment and from 2.0 to 4 in another embodiment. The 1% secant flexural modulus (ASTM D 790) of preferred plastomers range from 10 MPa to 150 MPa in one embodiment, and from 20 MPa to 100 MPa in another embodiment. Further, a preferred plastomer has a melting temperature (Tm) of from 30° C. to 80° C. (first melt peak) and from 50° C. to 125° C. (second melt peak) in one embodiment, and from 40° C. to 70° C. (first melt peak) and from 50° C. to 100° C. (second melt peak) in another embodiment.

In one or more embodiments above or elsewhere herein, the plastomer can be a copolymer of ethylene derived units and at least one of a C3 to C10 α-olefin derived units. The amount of comonomer (C3 to C10 α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

In one or more embodiments above or elsewhere herein, the plastomer can be one or more metallocene catalyzed copolymers of ethylene derived units and higher α-olefin derived units, such as propylene, 1-butene, 1-hexene and 1-octene. Preferably, the plastomer contains enough of one or more of those comonomer units to yield a density between 0.860 g/cm³ and 0.900 g/cm³. Examples of commercially available plastomers include: EXACT 4150, a copolymer of ethylene and 1-hexene, the 1-hexene derived units making up from 18 wt % to 22 wt % of the plastomer and having a density of 0.895 g/cm³ and MI of 3.5 dg/min (available from ExxonMobil Chemical Company); and EXACT 8201, a copolymer of ethylene and 1-octene, the 1-octene derived units making up from 26 wt % to 30 wt % of the plastomer, and having a density of 0.882 g/cm³ and MI of 1.0 dg/min (available from ExxonMobil Chemical Company).

Preferred blends for use as the molded material herein typically include of from about 15%, 20% or 25% to about 80%, 90% or 100% polymer by weight; optionally of from about 0%, 5%, or 10% to about 35%, 40%, or 50% filler by weight, and optionally of from about 0%, 5%, or 10% to about 35%, 40%, or 50% plastomer by weight. In one or more embodiments, a preferred blend contains one or more polymers described in an amount ranging from a low of about 15%, 20% or 25% to a high of about 80%, 90% or 100% polymer by weight. In one or more embodiments, a preferred blend contains at least about 1%, 5%, 10%, 15%, or 20% plastomer by weight. In one or more embodiments, a preferred blend contains at least about 1%, 5%, 10%, 15%, or 20% filler by weight.

Preferably, blends for use herein will have a tensile strength of at least 6,500 MPa, at least 7,500 MPa, or at least 9,000 MP tested according to ASTM D638. Further, preferred blends will have a flexural modulus of 1,750 MPa or more, such as about 1,800 MPa or more, or more than about 2,000 MPa tested according to ASTM D790.

In addition to the materials and polymers described above, one or more thermoplastic vulcanizates (TPV), thermoplastic elastomer (TPE), thermoplastic olefin (TPO), polyurethanes (PU), or elastomers such as EPR or EPDM can be used for areas or components that need to have sealing properties. Those material can be used in dense (non-foamed) or in foamed state. Most preferably, a TPV is selected due to the inherent mechanical properties that provide excellent sealing capability and the ability to be injection molded. The other aspect of materials will be the compatibalization of the structural and sealing materials, or the ability to adhere to each other. The materials of either the structural and/or sealing systems can be functionalized or have a secondary additive or component added to the material to provided good bondability.

As noted above, the degree of integration described can dramatically reduce the cost and assembly complexity of the finished door. Logistical costs, for example, are also significantly reduced, which reduces the amount of assembly errors in addition to the overall cost. Functional testing costs after final assembly are also reduced or eliminated because a majority of the functionality can be tested prior to final assembly (i.e., pre-tested). Further, the use of plastic materials in the door assembly can provide lower overall weight, more part integration, improved noise insulation, greater design freedom and will enable cheaper design modifications (i.e. using replaceable inserts in an injection molding tool).

The multi-material injection molding techniques described can also provide a unique combination of materials. Further, the number of secondary attachment techniques needed for multiple components such as rivets, screws, adhesives, clips, snaps, etc, is greatly reduced, if not eliminated all together in some instances.

In another embodiment, this invention relates to:

1. A door window system, comprising:

a core module,

a window track;

a window track glass guide operatively engaged with the window track to be guided along the profile of the window track;

a bracket integrally formed on the core module; and

a pulley attached to the bracket, wherein the pulley is in communication with a cable that is attached to the window track glass guide.

### 2. The door window system of paragraph 1, wherein the window track is integrally formed on the core module.

### 3. The door window system of paragraph 1 or 2, wherein a snap fit connection is integrally formed on the bracket and the pulley is attached to the bracket with the snap fit connection.

### 4. The door window system of any of paragraphs 1 to 3, further comprising a spacer integrally formed on the core module.

### 5. The door window system of any of paragraphs 1 to 4, further comprising a window motor housing integrally formed on the core module.

### 6. The door window system of any of paragraphs 1 to 5, wherein the bracket is injection molded from polypropylene.

### 7. The door window system of any of paragraphs 1 to 5, wherein the bracket is injection molded from one or more engineering resins.

8. The door window system of any of paragraphs 1 to 5, wherein the bracket is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
9. The door window system of any of paragraphs 1 to 5, wherein the bracket is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.
10. A door window system, comprising:

a door shell,

a window track;

a window track glass guide operatively engaged with the window track to be guided along the profile of the window track;

a bracket integrally formed on the door shell; and

a pulley attached to the bracket, wherein the pulley is in communication with a cable that is attached to the window track glass guide.

### 11. The door window system of paragraph 10, wherein the window track is integrally formed on the door shell.

### 12. The door window system of paragraph 10 or 11, wherein a snap fit connection is integrally formed on the bracket and the pulley is attached to the bracket with the snap fit connection.

### 13. The door window system of any of paragraphs 10 to 12, further comprising a spacer integrally formed on the door shell.

### 14. The door window system of any of paragraphs 10 to 13, further comprising a window motor housing integrally formed on the door shell.

### 15. The door window system of any of paragraphs 10 to 14, wherein the bracket is injection molded from polypropylene.

### 16. The door window system of any of paragraphs 10 to 15, wherein the bracket is injection molded from one or more engineering resins.

17. The door window system of any of paragraphs 10 to 15, wherein the bracket is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
18. The door window system of any of paragraphs 10 to 15, wherein the bracket is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.
19. A door window system, comprising:

a trim panel,

a window track;

a window track glass guide operatively engaged with the window track to be guided along the profile of the window track;

a bracket integrally formed on the trim panel; and

a pulley attached to the bracket, wherein the pulley is in communication with a cable that is attached to the window track glass guide.

### 20. The door window system of paragraph 19, wherein the window track is integrally formed on the trim panel.

### 21. The door window system of paragraph 19 or 20, wherein a snap fit connection is integrally formed on the bracket and the pulley is attached to the bracket with the snap fit connection.

### 22. The door window system of any of paragraphs 19 to 21, further comprising a spacer integrally formed on the trim panel.

### 23. The door window system of any of paragraphs 19 to 22, further comprising a window motor housing integrally formed on the trim panel.

### 24. The door window system of any of paragraphs 19 to 23, wherein the bracket is injection molded from polypropylene.

### 25. The door window system of any of paragraphs 19 to 23, wherein the bracket is injection molded from one or more engineering resins.

26. The door window system of any of paragraphs 19 to 23, wherein the bracket is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
27. The door window system of any of paragraphs 19 to 23, wherein the bracket is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

One of ordinary skill in the art will recognize that the door system described can be utilized as a complete system, or the individual components thereof can be utilized separately as individual mini-systems or modular type units to help consolidate two or more components if desired.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents, including priority documents, cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A door window system, comprising:
a core module,
a window track;
a window track glass guide operatively engaged with the window track to be guided along the profile of the window track;
a bracket integrally formed on the core module; and
a pulley attached to the bracket, wherein the pulley is in communication with a cable that is attached to the window track glass guide.

2. The door window system of claim 1, wherein the window track is integrally formed on the core module.

3. The door window system of claim 1. wherein a snap fit connection is integrally formed on the bracket and the pulley is attached to the bracket with the snap fit connection.

4. The door window system of claim 1, further comprising a spacer integrally formed on the core module.

5. The door window system of claim 1, further comprising a window motor housing integrally formed on the core module.

6. The door window system of claim 1, wherein the bracket is injection molded from polypropylene.

7. The door window system of claim 1, wherein the bracket is injection molded from one or more engineering resins.

8. The door window system of claim 7, wherein the bracket is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

9. The door window system of claim 7, wherein the bracket is injection molded from one or more engineering resins selected from the group consisting of polybutylene terephthalate (PBT), polyethylene terephthalate (PET), polyethylene isoplflhalate (PEI), PET/PEI copolymer, polyacrylate (PAR), polybutylene naphthalate (PBN), liquid crystal polyester, polyoxalkylene diimide diacid/polybutyrate terephthalate copolymer, polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

10. A door window system, comprising:
a door shell,
a window track;
a window track glass guide operatively engaged with the window track to be guided along the profile of the window track;
a bracket integrally formed on the door shell; and
a pulley attached to the bracket, wherein the pulley is in communication with a cable that is attached to the window track glass guide.

11. The door window system of claim 10, wherein the window track is integrally formed on the door shell.

12. The door window system of claim 10, wherein a snap fit connection is integrally formed on the bracket and the pulley is attached to the bracket with the snap fit connection.

13. The door window system of claim 10, further comprising a spacer integrally formed on the door shell.

14. The door window system of claim 10, further comprising a window motor housing integrally formed on the door shell.

15. The door window system of claim 10, wherein the bracket is injection molded from polypropylene.

16. The door window system of claim 10, wherein the bracket is injection molded from one or more engineering resins.

17. The door window system of claim 16, wherein the bracket is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

18. The door window system of claim 16, wherein the bracket is injection molded from one or more engineering resins selected from the group consisting of polybutylene terephthalate (PBT), polyethylene terephthalate (PET), polyethylene isophthalate (PEL), PET/PEl copolymer, polyacrylate (PAR), polybutylene naphthalate (PBN), liquid crystal polyester, polyoxalkylene diimide diacid/polybutyrate terephthalate copolymer. Polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

19. A door window system, comprising:
a trim panel,
a window track;
a window track glass guide operatively engaged with the window track to be guided along the profile of the window track;
a bracket integrally formed on the trim panel; and
a pulley attached to the bracket, wherein the pulley is in communication with a cable that is attached to the window track glass guide.

20. The door window system of claim 19, wherein the window track is integrally formed on the trim panel.

21. The door window system of claim 19, wherein a snap fit connection is integrally formed on the bracket and the pulley is attached to the bracket with the snap fit connection.

22. The door window system of claim 19, further comprising a spacer integrally formed on the trim panel.

23. The door window system of claim 19, further comprising a window motor housing integrally formed on the trim panel.

24. The door window system of claim 19, wherein the bracket is injection molded from polypropylene.

25. The door window system of claim 19, wherein the bracket is injection molded from one or more engineering resins.

26. The door window system of claim 19, wherein the bracket is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

27. The door window system of claim 19, wherein the bracket is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. Polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.
